(19) United States
(12) Patent Application Publication
(10) Pub. No.: US 2014/0214710 A1
(43) Pub. Date: Jul. 31, 2014

(54) Job Search Diagnostic, Strategy and Execution System and Method

(71) Applicants: Peter Dubner, Easton, CT (US); Paul Stuhlman, East Haddam, CT (US)

(72) Inventors: Peter Dubner, Easton, CT (US); Paul Stuhlman, East Haddam, CT (US)

(21) Appl. No.: 14/154,685

(22) Filed: Jan. 14, 2014

Related U.S. Application Data
(60) Provisional application No. 61/757,317, filed on Jan. 28, 2013.

(51) Int. Cl. G06Q 10/10

(52) U.S. Cl. CPC G06Q 10/1053
USPC 705/321

(57) ABSTRACT

An apparatus, system and method for helping a job seeker diagnose and improve the efficiency and effectiveness of a job search. A Job Search Diagnostic of the present invention helps a job seeker secure a new job more quickly, by identifying the specific problem areas in a search that are limiting progress and to identify those areas that will yield the greatest beneficial impact and by offering specific recommendations and guidance for how to improve in these problem areas. Diagnostic results can be highly individualized and may be based on the unique characteristics of an individual job search as well as the weighted importance of different areas of the search, and can be achieved through use of expert knowledge and logic and using a wide array of both individual generated and other available information including an individual's job search skills, employment search attributes, job seeker qualifications as well as job market and hiring environment realities. Additional information such as the mental and emotional characteristics of a job seeker can also be used to create a variety of data and reports to assist the job seeker and others to improve the efficiency and effectiveness of job searches.

### BACKGROUND OF THE INVENTION

Obtaining a new job, especially while unemployed, can be a very complex, difficult and lengthy process, particularly given the recent difficult economic conditions and explosive technology trends. A successful job search can take three months to a year, and in many cases even longer, depending upon a wide array of factors. These factors range from the personal situation of the job seeker to broad environmental factors, such as the economy as a whole and the hiring status of a particular industry, geographic, and/or functional job market. A few of the many specific factors affecting the job search include: occupation, level of experience, employment status, work history, education, age, salary range, industry, function, personal characteristics, family situation, willingness/preference to relocate, region of the country or world of the job seeker, and others.

In addition, conducting an effective job search requires a significant amount of knowledge of and skill in a wide range of areas such as interviewing effectively, using social media networks and creating a targeted resume, to name just a few of the many areas involved. Unfortunately, most job seekers are not even aware of all of the areas involved. The aforementioned areas of interviewing, social media, and resume are some of the more obvious areas, but other areas such as using metrics to measure one's search, assessing market demand, and creating a profile to enhance networking effectiveness, are far less obvious. Exacerbating this “the job seeker does not know what he/she does not know” phenomenon, many job seekers also lack the skills and competencies required in many of these areas. For example, they may be poorly skilled at interviewing or at understanding their highest probability target markets.

Furthermore, when a job seeker is unemployed, the accompanying personal, financial, family, and emotional pressures can make the task even more difficult. For many, maintaining emotional and mental wellness is actually the most challenging aspect of conducting a job search. Moreover, if not managed well, these emotional pressures can dramatically diminish the effectiveness of a job seeker's efforts. As a simple example, an unemployed job seeker may interview poorly because they are lacking in confidence. This can all contribute to a downward spiral and result in long-term, even permanent unemployment for some.

While there a number of resources available to help job seekers in their efforts, they are not customized to the specific needs of the individual and therefore lacking in effectiveness. Other approaches that are customized and more effective, such as individual personal coaching, are often cost prohibitive to the unemployed job seeker who is often attempting to minimize their expenses.

Because of these many inter-related factors: the challenging economic conditions and rapidly changing technological environment, the complexity of the job search process, the general lack of understanding of what's involved in an effective search, the absence of skills and competencies required to conduct a search, the emotional challenges that exacerbate the search process, and the reluctance or inability to purchase effective job search resources, many individuals remain unemployed far longer than necessary, creating extreme financial and emotional hardship for the individuals and negatively affecting the overall U.S. economy.

### BRIEF SUMMARY OF THE DRAWINGS

FIG. 1 shows a summary level flow chart of the method and system of the present invention;

FIG. 2 shows one example of how key activities are tracked over time relative to “networking” aspects of a job search; and

FIG. 3 shows an example job search action plan.

### BRIEF SUMMARY OF THE INVENTION

The present invention generally described relates to systems, apparatuses, tools and/or methods (hereinafter as may be collectively referred to as “Tools”) for helping a job seeker diagnosis and improve the efficiency and effectiveness of their job search so they can obtain a new job more quickly. Other objectives, elements and advantages of the present invention are described in greater detail above and below, to include in the specification, drawings, Appendix, claims and other information provided and/or referenced in this application.

The Tools of the present invention system help a job seeker diagnose and improve the effectiveness of their job search so they can obtain a new job more quickly. The present invention helps a job seeker secure a new job more quickly, by identifying the specific problem areas in his or her job search that are limiting progress, prioritizing or ranking these problem areas to identify those that will yield the greatest beneficial impact if improved, by offering specific recommendations and guidance for how to improve in these problem areas, by providing a structured method of developing an Action Plan to incorporate these recommendations, and providing a means to track progress against the Action Plan.

The Tools (and the Job Search Diagnostic in particular) of the present invention are quite different from other job search resources in the manner in which they accommodate, process, score, display and otherwise explain to the job seeker the very specific differentiated needs and situation of each particular job seeker. Job seekers and the elements of their searches vary considerably based on many factors including but not limited to the personal characteristics, family situation, willingness/preference to relocate (or not), occupation, level of experience, work history, education, age, salary range, industry, function, region of the country or world of the job seeker and other factors that will be explained and compared in the examples provided above and below. Job search skills in many areas (such as social media, networking, and interviewing), as well as the job seeker's emotional and mental resilience, state of mind and other individual characteristics as well as additional individual differences as they may relate to the job search and job market(s) also vary and contribute to significant differences among job seekers. In order to maximize job search effectiveness, it is important that each job seeker receive guidance and advice appropriate to their particular situation and needs, not generalized advice that may not be applicable or helpful in their situation. The Tools of the present invention in particular can identify problem areas, areas for improvement and provide personalized guidance based on the very specific and differentiated needs of the individual, something other resources are not able to do.

More particularly, the Tools provide weighted diagnostic results aimed at, logically, maximizing the improvement of the job search in a manner deemed to create the greatest value for the job seeker. By way of general example, to the extent that a job seeker's skill in one required area of a job search (e.g. working with recruiters) is objectively and systematically through use of logic and expert systems, determined to be less than another required skill (e.g. use of job boards), the Tools can recommend a prioritization of efforts on the weaker skill, i.e. working with recruiters, to therefore optimize the job seeker's overall efforts. By way of further example, in the preceding case, the prioritization can be modified through use of expert knowledge and logic based on the significance or importance of the different areas of the search which are determined by the job seeker's individual situation (e.g. if the job seeker is a senior executive, more weight would be given to recruiters than job boards since working with recruiters is a more important job search tactic for senior executives than it is for individual contributors). By way of further example, the Tools can help the job seeker assess the likelihood of successfully obtaining a role in an industry area other than their most recent one, by taking into account their functional area of expertise (in that some functional roles can transfer more easily across industries, e.g. a company may be more willing to hire a Human Resources executive without relevant industry experience than it would be to hire a Manufacturing executive without that industry experience). By way of further example, to the extent that a job seeker lacks a particular skill or experience based on evaluation of the information provided to the Tools, the Tools can recommend, for example, a different approach to constructing a resume or interviewing such as by describing the experiences of the job seeker in a manner more consistent with the requirements of particular employers in an industry or set of related industries. By way of further example, the Tools can provide differentiated sets of recommended action items including courses, seminars, networking efforts, social/internet media activities, volunteer opportunities or many other activities and actions based on the different characteristics and/or skills of the job seeker that might increase the automated or human reader “match score” of a job seeker, thus improving the likelihood that the job seeker will obtain an interview or succeed during the interview.

### DETAILED DESCRIPTION OF THE INVENTION

The present invention overcomes many problems with pre-existing systems, devices, methods and other resources used by job seekers. Job search resource materials such as books, web sites, and blogs are by their nature, addressed to a broad audience and are one-way in their communication, i.e. they provide but do not receive information. As a result they are not able to assess the individual characteristics of a given job seeker and provide individualized advice. The generalized information and advice provided by these resources can be not only unhelpful, it can actually cause a negative effect on the job seeker's efforts (e.g. a professional with 15 years' experience receiving inappropriate advice that his/her resume should be limited to one page in length, advice that is often appropriate for professionals with less experience). Even expert job search coach advice can lack one or more desirable features, including: 1) customization (the results provided can be too “general”, in that the output/information provided to the job seeker is not based on the specific needs of the individuals as experienced in the context of the many factors outlined above and below); 2) objectivity (such as misinterpretations by a listener of job seeker answers to oral questions not always asked in the same order or context); 3) comprehensiveness (such as not all critical elements of available information being taken into account or poorly optimized ordering and/or selection of questions most relevant to the many factors described above and below relevant to the job seeker and job market(s)); 4) understandability (such as providing appropriate written description and perhaps more importantly, graphic, modeling, multidimensional output/expression that allows the job seeker to objectively visualize and understand the impact of the many factors at play in a job search on the effectiveness, efficiency and “bang for the buck” improvement potential for that search).

In particular, relative to 4) above, the Job Search Diagnostic, Tools and other aspects of the present invention can present information to each job seeker in a manner consistent with that users ability to understand and optimize information provided. For example, for job seekers who understand visual information more readily than verbal or written, the Tool can present information to the job seeker using three-dimensional bar, pie chart, line, etc. graphics that communicate information (and moving/shifting graphs to help the user visualize positive results from certain modest adjustments, in a manner well understood to such individuals.) In another example, such as for an experienced financial analyst job seeker) graphic information and accompanying information can be provided so as to be most readily understood by one who works with balance sheets, complex financial equations and the like. As yet another example, for an entry level design architect job seeker, information and a structural model graphics can be employed to maximize the impact of the information provided by the tool.

The Tools in the present invention are an improvement over other methods, devices, systems, and resources in other important ways. Because the Tools employ consistent, comprehensive, and systematic data collection processes, by employing the Tools with a wide range of individuals, a large database of job search data, attributes, activities, and results can be created which can be used for functions that are helpful to individual job seekers. By way of example, a job seeker's responses, results, capabilities and scores can be compared to a large population of similar job seekers thus enabling the job seeker to understand how he/she compares to competitors for similar positions. By way of further example, through the use of the large population database of collected responses, capabilities, scores and results through the Tools, the Tools can provide expert advice by correlating through logical and mathematical means, the activities, skills, and behaviors that will create the most beneficial job search results. For example, if it is determined that high social media activity in one particular venue (e.g. Twitter® social media) for marketing professionals has a high direct correlation with increased numbers of screening interviews, a job seeker with a background in marketing can be advised to increase his/her social media activity in that venue to obtain more interviews.

Assessing the effectiveness of a job search in accordance with the present invention can include generating employment search attributes, job seeker qualifications, job market conditions, employer hiring environment realities and other factors and variables described above and below. The present invention may be embodied in a specialized device for assessing and/or conducting a job search or as employed in a variety of computing devices including personal computers, digital tablets such as Apple® iPad® devices, smartphones and other devices with a keyboard, touch screen/pad, visual display, video, audio, sound and other means for communication, for both accepting/gathering information from and providing information to a wide variety of sources, including individuals/groups of users in person and/or remotely, web/internet sites, databases, memory (local or remote) and other sources to include as more fully detailed herein. All such sources of information can be combined into what can be described as a variably structured data overlay that is used to collect and use the information. The present invention can employ scoring systems and methods as more fully described below into a variably structured data overlay to derive one or more job search effectiveness ratings and detailed data package that may include the strengths and weaknesses and other qualities (or shortcomings) concerning the effectiveness of the job search of a job seeker or a group of job seekers. Job search effectiveness rating(s) and detailed data as described above and below can be communicated to users in a multidimensional report on paper or on a device using text, images, graphic representations, sound, video and otherwise as described herein. Other types of information, including but not limited to certain mental and emotional characteristics of a job seeker as may be relevant to a job search can also be employed in the present invention. This information can be input into a device and/or in accordance with the method of the present invention, and can likewise be scored according to the variably structured data overlay, to be summarized and/or detailed as part of the multidimensional report.

The present invention can also include biometric elements, such as a camera and/or microphone and associated hardware and software to monitor visual and verbal inputs, emotional responses and overall mental state of a user. Stress and other emotional and metal states can be detected in voice patterns, eye and body movements, changes in voice tone and volume and other information from as user. Such information can also measure relative comfort (or discomfort) in being interviewed and other information affecting job search effectiveness. Other biometric elements used to provide information in accordance with the present invention can include a pulse oximeter, blood pressure monitoring and/or electronic sensors (such as may be in contact with a user's finger to monitor electrical impulses in the body) to also to indicate stress levels, elevated heart rate and/or other information as may help job seekers and job search coach to understand the many factors affecting a job search. Biometrics elements can also include height, weight, appearance, and other aspects of the job seeker, that can affect the perceptions of potential employers.

Once again, the generalized advice dispensed by resources that do not include the elements of the present invention (even including expensive experts with limited time to evaluate each situation) is often sub-optimal or even harmful to the job seeker, in that these resources fail to account the specific needs, idiosyncrasies and characteristics of the individual job seeker and the job market(s) in which a position is being sought.

Embodiments of the Tools of the present invention surpass other resources, systems and experts in that they first objectively, systematically and comprehensively collect information about the individual job seeker, and then based on the unique situation, information, relevant/weighted factors and intelligent/expert knowledge about how this unique information affects one's job search (hereinafter, “Profile”), they customize the advice and different elements of expression of that advice for each individual so that it can be most effectively understood and put to use in executing a job search strategy.

The collection of information used in certain embodiments of the present invention can come from questions intended to elicit candid responses from one or more job seekers, from one or more web search engines operating on a specialized or other computing device, information extracted from job seeker data sources, and otherwise as described herein. In addition, the various artifacts of a job seeker, such as a LinkedIn® social media profile or recommendation, or other forms of digital information about a job seeker discovered by or included in Google®, Facebook®, YouTube® audio, video and other web sites and social media, as well as audible/visual inputs, scanned documents, email and many other sources of information can also contribute to the variably structured data overlay in the present invention. In addition, receiving input about the job seeker from other individuals through automated surveys or other means, can also contribute to the variably structured data overlay. The variably structured data overlay of the present invention that encompasses the above described collection of information is more comprehensive and complete than information used by other job seeker resources that fail to take into account more relevant and complete information needed to provide comprehensive, effective and personalized job search advice. In this manner, the Tools of the present invention can function in a manner that can surpass advice from an expert job search coach by systematically understanding the unique needs and situation of an individual, taking into account a more complete information set about and relating to the job seeker and their situation, and then offering advice based on the many factors involved and the interrelationship and relative weighting/importance of those factors.

The methods of and devices for obtaining input from a job seeker in the present invention can vary broadly, to include as referenced above, the completion of a questionnaire on a computer or specialized device of the present invention, or for that matter in paper or other form for scanned and/or other methods of input into the tool. Other methods of obtaining job seeker information in the Tool of the present invention can substitute for, or be used in conjunction with the responses to questions provided by the job seeker. By way of example, images, audio recordings and video recordings of the job seeker, as well as input about the job seeker from others, can be used as additional input to cross-check for consistency against questions asked of the job seeker about his/her interviewing competencies. By way of further example, automated search engine results can be used to cross check and supplement responses that the job seeker provides about social media activity.

In addition, in certain embodiments of the Tools, information about the job seeker that is loaded into the Tools can be cross-checked for internal consistency and for consistency with external norms and averages and for consistency with a large database of other job seeker responses to the Tools as described above and below. For example, the Tools can collect two different types of information about the job seeker's interviewing skills. One type could include the job seeker's self-appraisal of interviewing effectiveness through response to questions. Another type could include a comparison of number of offers received per number of interviews conducted, compared with a large job seeker population. If the two types of interviewing effectiveness measures described above are inconsistent, the Tools can identify the inconsistency and recommend specific follow up analysis and actions. In this way, problems in a job seeker's situation can be identified that would not be known through other job seeker resources. In another example, if the digital artifacts of a job seeker, such as their Facebook® profile is determined by the Tools to be unfavorably viewed by employers, this information can be correlated to the lack of interviews or offers they may be receiving. In another example, the interview success rate of a job seeker of a particular age applying to certain types of positions, could be compared to success rates of a large population of job seekers of various ages to determine if the job seeker is potentially applying to jobs which have a low probability of success based on their age.

In that obtaining employment is the ultimate goal of a job seeker, the objective manner in which the Tools evaluate and process information can be of significant importance in increasing the overall effectiveness of the job search. For example, information provided in the responses to a detailed questionnaire or from the logical and quantitative evaluation of the terms in a resume, LinkedIn® profile and many other forms of information in which the job seeker describes his or her qualifications can be evaluated by the Tools automatically such as by output of “issue notes” (with specific descriptions of the mismatches, errors and/or other clear problems) to the job seeker, a career coach, peer or other person who can apply their expertise and logic to help the job seeker identify and correct the specific or general issues negatively affecting the job search and to work with and for the job seeker to correct those issues.

Other elements and advantages of the Tools can include the use of a pre-determined set of job search characteristics (hereinafter “Characteristics”) about job seekers that can account for and/or cause differences in job searches. These Characteristics can include items such as geographic location, employment status, length of time unemployed, level, functional expertise, industry expertise, age, gender, educational level, cash compensation and others as referenced above and below. Another element and advantage of the Tools is that they can include the use of a pre-determined set of job search factors (hereinafter “Factors”) that are determined and known by experts in job search to correlate with success or lack thereof in the job search process. By using standard sets of Characteristics and Factors, a more disciplined, analytical determination of probable causes of job search difficulties as well as recommended solutions can be determined, than could otherwise be accomplished by other resources, including job search coaches that do not employ such standard sets of Characteristics and Factors.

One embodiment of the present invention uses an effective set of Factors that include the following:

1.1 Focus—The degree to which a job seeker has a clear focus on job search objectives

1.2 Fit—Job seeker qualifications relative to new position objective(s)

1.3 Credentials—The caliber of job seeker professional and educational qualifications, skills and credentials

1.4 Personal Attributes—Personal attributes of the job seeker, such as appearance and enthusiasm that affect how others react to the job seeker during interviews and other encounters

1.5 Market Demand—the strength and size of a job seeker's potential market, i.e. the number of potential opportunities available to a person with the job seeker's experience, qualifications, credentials and other job market environmental factors.

2.1 Resume—the quality of this fundamental self-marketing document reflecting the job seeker's background, credentials, accomplishments, and value.

2.2 LinkedIn® and other social media—the job seeker's ability to use LinkedIn® and other crucial social media applications to their advantage in the job search.

2.3 Messaging—the job seeker's portfolio of additional oral and written job search messaging materials and information.

2.4 Networking—the skill in interacting with a range of other people in the job search process to increase market awareness and gain important information and access to additional contacts.

2.5 Recruiters—a job seeker's knowledge about and ability to leverage this often important channel to the job market.

2.6 Job Boards—a job seeker's effectiveness in using this broad channel to access the visible/published job market

2.7 Brand Awareness—the productive use of other awareness-generating job search techniques, such as speaking at industry events or using social media venues.

2.8 Interviewing—the ability of the job search candidate to successfully help employers understand how he/she will meet the employer's needs and therefore receive an offer.

2.9 Negotiating—a job seeker's competence in striking the right bargain and successfully finalizing an employment offer.

2.10 Search Management—the organizational Tools and techniques that bring structure and effectiveness to a job search.

2.11 Metrics-Effort—the numerical measures of the quality and quantity of job search efforts (such as time spent on job search activities).

2.12 Metrics-Results—the effectiveness in generating job opportunities and converting opportunities into offers.

3.1 Drivers—job seeker motivation and desire to succeed, and the effort the job seeker is willing to invest in the search.

3.2 Paradigms—the job seeker's underlying beliefs about the job search process that play a pivotal role in how the search is executed

3.3 Adaptors—job seeker willingness and ability to manage change and embrace new ideas

3.4 Attitudes—the degree to which certain positive attitudes, such as resiliency, persistence and optimism, are present in the job seeker's search

3.5 Habits—the constructive personal and job search routines maintained by the job seeker to support job search efforts.

Another element and advantage of the Tools is that it can employ a hierarchical structure of Characteristics and/or Factors so that levels of detail can be consistently summarized and simplified, therefore improving the comprehensibility by the user. One embodiment of the present invention uses a set of principles which is a hierarchical summary of multiple Factors (hereinafter referred to as “Principles”). The Principles used in one embodiment of the present invention are:

1.0 Market Realities—The Factors that collectively comprise the job seeker's best fit in the job market (see Factors 1.1 through 1.5 above).

2.0 Search Execution—The Factors that collectively comprise the job seeker's knowledge of and ability to execute comprehensive job search strategies and tactics (see Factors 2.1 through 2.12 above).

3.0 Inner Game—The Factors that collectively comprise the job seeker's mental and emotional fitness as it relates to job search activities (see Factors 3.1 through 3.5 above).

The above list of Characteristics, Factors and Principles, as reflected in one embodiment of the invention, is particularly comprehensive, and also unusual in that it includes aspects of a job search that are critically important but generally overlooked by other resources including job search coaches. A few examples of such critical, unusual and often overlooked Factors include: 1.4 Personal Attributes, 1.5 Market Demand, 2.10 Search Management, 2.11 Metrics-Effort, and 2.12 Metrics-Results. Principle 3.0, Inner Game, which includes Factors 3.1 through 3.5, is also critical but often overlooked in its entirety by other resources.

The use of a pre-determined set of Characteristics, Factors, Principles and other situational information can have a significant influence on job search effectiveness. A framework to organize the information, Characteristics, Factors, and Principles described above (and otherwise herein) as provided by the diagnostic aspects of the Tool of the present invention can help the job seeker understand what the most important elements are in each situation and how these relate to search effectiveness. An organizing framework also facilitates creation of a hierarchy of Factors most relevant to a particular job seeker's situation. For example, in one embodiment of the present invention, as shown as the top three priority items on the “Job Search Diagnostic™—Your Job Search Priorities” portion of Section 2 of the Appendix, a job seeker may be advised by the Tools that Factors 2.4, 2.2 and 2.11 (Networking, LinkedIn® and Metrics-Effort) might be selected/sorted out of the exemplary 22 Factors listed above as being particularly important and the areas in which such job seeker should focus his/her efforts in order to accelerate progress in the job search.

As described above, series of questions (thoughtfully ordered and logically sorted by the Tools) can be asked of a job seeker to determine the job seeker's unique values for each of the exemplary 22 Factors and a related/add-on series of questions adapted to the situation(s) present to determine the job seeker's unique situation, status, condition and/or capability. A sample set of questions for the job seeker is provided in Section 1 of the Appendix. A sample report of feedback for the job seeker is provided in Section 2 of the Appendix.

Another element and advantage of the Tools is that it can incorporate a set of expert logic and rules that can be used to determine the areas that are particularly important and in which such job seeker should focus his/her efforts in order to accelerate progress in the job search. By way of example, if, by way of one or more forms of input described above, a job seeker is determined to be an entry level professional, then their priorities for focus might be more heavily weighted toward the use of job boards than the use of recruiters (since job boards will be more effective than recruiters for an entry level professional). By way of further example, the Tools can use expert logic to determine if the job seeker is spending his or her time on the right activities, by comparing his/her time actually spent to norms that are known by experts to produce optimal results, e.g. if time spent by a job seeker on networking is less than 50% of total time spent on all activities, then that item could be prioritized for action. Expert logic can be used in determining scores and priorities as illustrated in Section 2 of the Appendix.

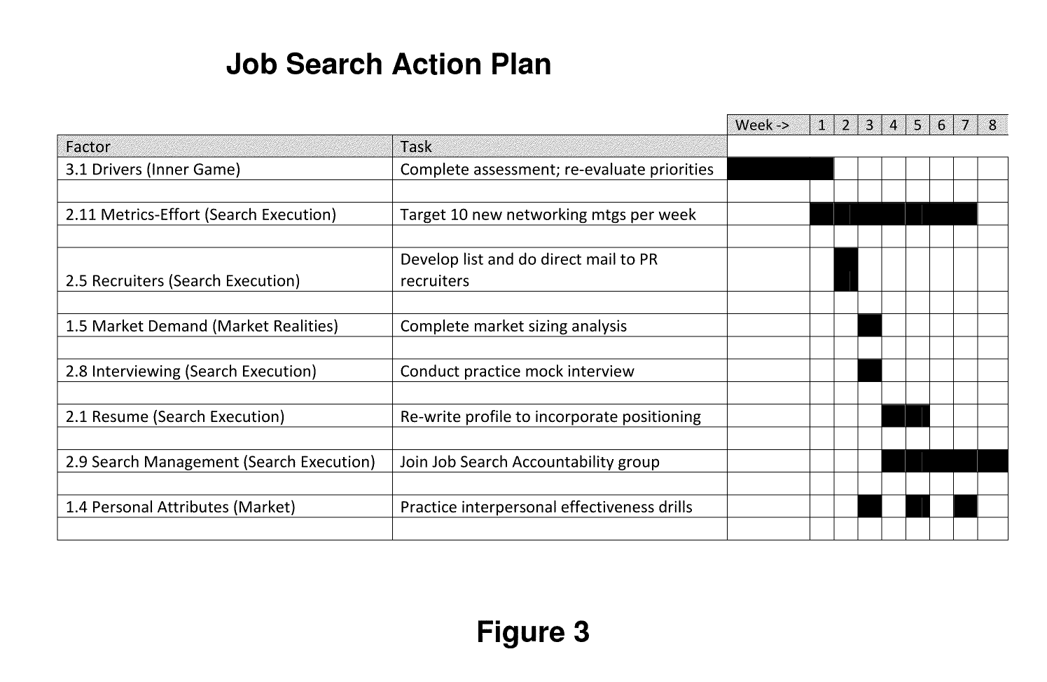

In one embodiment of the present invention, once a job seeker's top priorities for improvement are identified, then additional information about each of those Factors along with recommended action items and advice can be provided to the job seeker. Section 3 of the Appendix is an example of a resource guide that provides additional information, advice and action items for a job seeker, assuming in this case that Factors 1.5, 2.4 and 3.1 were identified by the Tools as key areas of priority and focus. Specific action items can be generated by the Tools that are customized to the needs of the specific job seeker through use of expert logic as described above and a pre-determined library of action items. In this example, Factors 1.5, 2.4 and 3.1 have been selected as areas needing the greatest improvement by the job seeker. In this manner, embodiments of the tool of the present invention can identify particular areas in which the job seeker can with efficiency, limited effort, and particular positive impact, greatly increase the effectiveness of the job search. By providing the job seeker with additional information and action items which collectively can comprise or be incorporated into an Action Plan, the job seeker can then focus his/her efforts on the specific actions that will yield the most positive results on their search based on their own unique needs and situation. In one embodiment of the present invention, once multiple areas of improvement and action items for each have been identified, an organizing framework can be created such as shown in FIG. 3 and on the “Job Search Action Plan” portion of Section 2 of the Appendix 9. These organizing frameworks have the benefit of helping the job seeker monitor and accomplish the items which will most productively contribute to job search success.

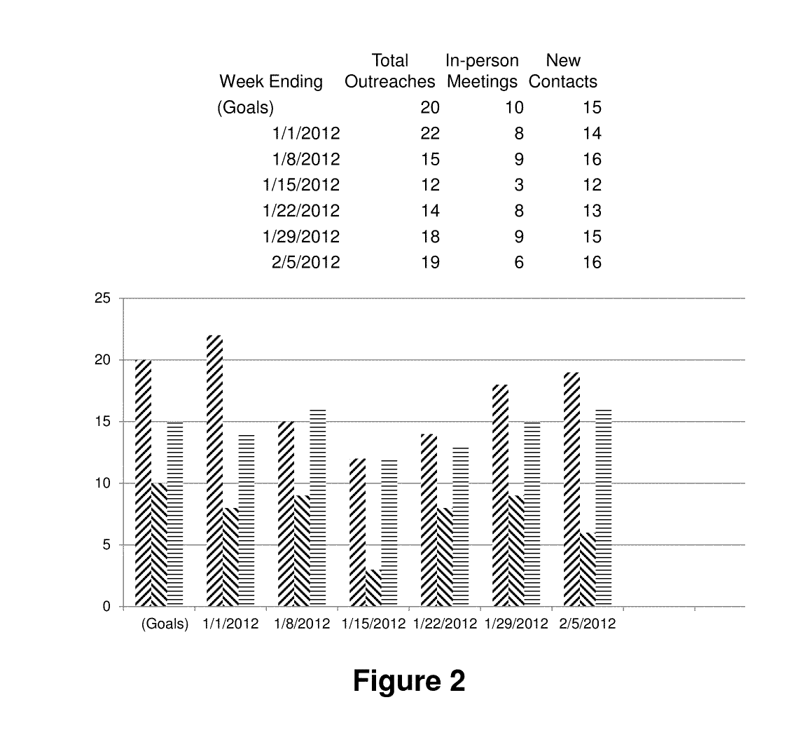

The body of job search knowledge can also be readily collected and frequently updated for the Tool, as can recommended action steps for the job seeker to use based on the specific feedback generated such as shown in Sections 2 and 3 of the Appendix and FIG. 3. In particular, the situational selection and organizing approach can to be used to select focused, search-enhancing action steps such as shown by example in Section 3 of the Appendix and FIG. 3. In addition, the job search data as well as supplemental data can be tracked by the Tools over time to provide the user with feedback on achieving goals established in the Action Plan. See for example FIG. 2 in which three key activities are tracked over time relative to the Factor entitled Networking.

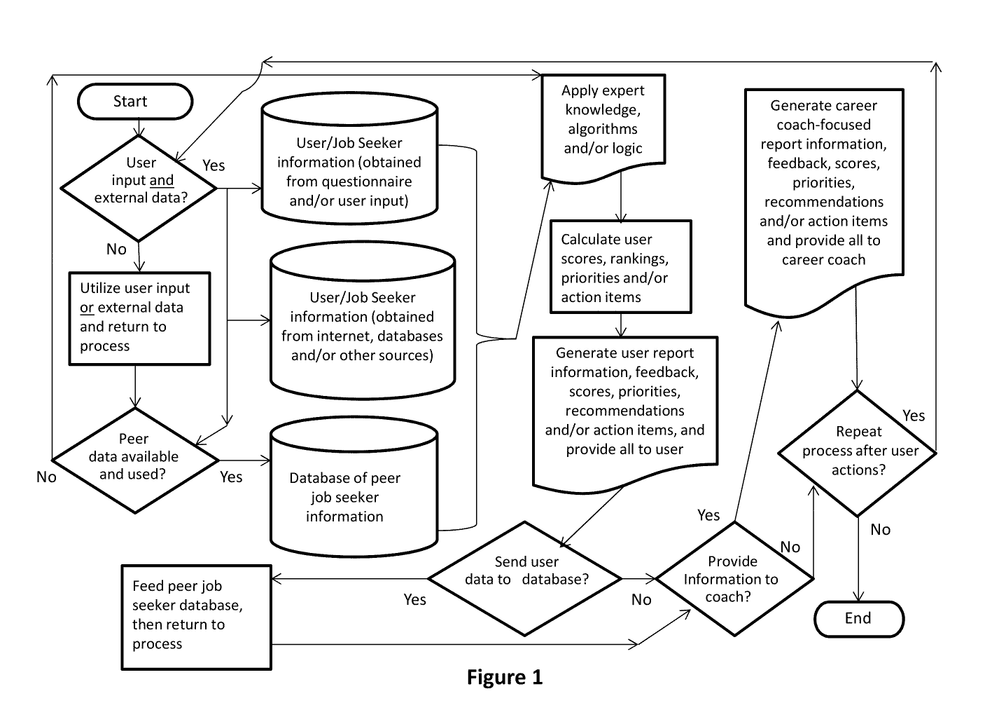

FIG. 1 shows in a summary level flow chart certain embodiments of the present invention. The process begins with the collection of information from the job seeker (such as in the form of responses to the questions posed in Section 1 of the Appendix) and/or the collection of external information about the job seeker (such obtained from internet, databases and/or other sources otherwise described herein). If peer job seeker information is available and its use is desired, a database of peer job seeker information can be accessed (from a database of information obtained from other users of this invention and/or online/internet sources with information about other job seekers deemed to be in a peer group with the user job seeker). According to the respective three “data silos” of FIG. 1 as may be employed in the present invention, expert knowledge, algorithms and/or logic is applied to the available data to evaluate the impact of Characteristics, Factors and other information being processed. In one embodiment as shown in FIG. 1, the system then performs the logical tests to calculate user scores, rankings, priorities, and/or action items. User feedback is thereafter generated (charts, graphs, symbology, visual information, text, audible information, and as otherwise described herein) to effectively communicate and explain the results of evaluation in accordance with an organized framework. In this manner, relevant job search knowledge and recommendations for the job seeker are thereby based on the specific results generated for that job seeker, and provided in a well-ordered approach to help the job seeker understand and execute on the recommendations/action items provided. FIG. 1 also shows how information can be supplied to the database of the user's peer job seekers, and how a report can be generated for use by a career coach which can be used to counsel the job seeker. Also as shown in FIG. 1, as and when actions to improve search effectiveness are taken by the job seeker, user can then repeat the process. In this manner, by monitoring and tracking actions against recommendations, and evaluating progress using the Tools and methods described herein, a “feedback loop” will further help the job seeker make progress toward his/her goals.

The Appendix and FIGS. 1-3 demonstrate the unexpected result in the present invention so as to communicate with the user analytical insights into the efficiency and effectiveness of the job search. Questions to the job seeker are ordered and collected, information is analyzed through the use of expert logic, and priorities and proposed action items are determined. Information is communicated to the user in text, graphic, and or other forms, in a manner most consistent with the job seeker's ability to understand it. These results are accomplished in a manner that is more accurate, efficient, effective and/or free from potential biases than can be accomplished by an experienced career coach. Through the automated analysis logic (as may be variably adapted to different Characteristics, Factors and other information relevant to a particular job search), the Tool of the present invention can in many ways surpass the capabilities of a career coach personally assisting a job seeker.

In certain embodiments of the present invention, a multidimensional report may include or be customized to provide a comprehensive overview on the effectiveness of the job search by the job seeker as may be useful for a career counselor or job search coach to assist the job seeker. For example, the report may include data on the specifics of the job search—such as how job seekers can maximize their opportunities by attending trade association meetings, including key elements of that experience that have proven to be particularly important to potential employers. A report generated for a job search coach in accordance with the present invention report may include a set of suggested ways to point out in verbal conversation with a job seeker how to enhance their job seeker probabilities for success in a positive manner (without appearing to criticize the job seeker).

Embodiments of the Tools, which use refined algorithms and a series of logical tests based on expert knowledge to analyze and evaluate the responses provided to the questions and or other information provided as described above or below can be used to more objectively determine the impact and significance of each of the Characteristics, Factors and other information in diagnosing and providing improvement advice to enhance the job seeker's search effectiveness.

A computing program along with necessary general or customized/specially adapted computing equipment can be used to pose and answer questions, to perform the logical tests, execute algorithms and otherwise process and evaluate information collected and ultimately provided as multidimensional report feedback in many forms as described herein.

System logic is used to calculate room for improvement as an “RFI score” as relates to the Factors (as described above) in the job search, for example as shown on “Job Search Diagnostic™—Your Job Search Priorities” portion of Section 2 of the Appendix. A computing program along with necessary general or customized/specially adapted computing equipment can be used to pose and answer questions, to perform the logical tests, execute algorithms and otherwise process and evaluate information collected and ultimately provided as feedback in all forms described herein to users of the Tool. RFI scoring is again an example of how the present invention enables a job seeker to maximize the positive impact of changes made in the conduct of a job search. In this manner, a job seeker can also select changes using the present invention that more efficiently increase the effectiveness of the job search.

More specifically, an RFI score can be based on strengths and weaknesses and so as to arrive at a prioritized ranking of inhibitors to job search effectiveness. This RFI score may be included in a detailed data package so as to be printed, displayed, heard and/or watched by users of the present invention. A prioritized list of RFI score elements and/or action items for improving job search effectiveness can be communicated as described above and below in embodiments of the present invention. Multidimensional reports that comparatively score and/or show relevant trending of job search effectiveness over time can be communicated to job seekers, job search coaches, and others. Multidimensional reports on the efforts and situation of one job seeker can also be comparatively scored relative to the efforts and situations of one or more other job seekers. One or more sets of prioritized success factors proven to improve job search effectiveness can also be created and communicated according to the present invention.

As described above and as illustrated in FIGS. 1-3 and the Appendix, adaptable logic is used to determine the job seeker's effectiveness for each of the Factors described above as well as in determining specific recommendations, advice and action items for the job seeker. The Tools process the job seeker's responses to questions such as those shown in the Section 1 of the Appendix example, and applies the logic, tests and algorithms describe herein. The job seeker has provided specific personal, professional and environmental job search information, and thereafter received a personalized assessment of their job search effectiveness across comprehensive array of important factors organized in a manner in which they can readily understand their strengths and deficiencies, such as shown in Sections 2 and 3 of the Appendix.

The job seeker also receives additional information about these factors and prioritized recommendations for improvement based on their personal situation and Characteristics, as well as an organizing framework for implementation and tracking. By following these recommendations in the prescribed manner, the job seeker improves his or her effectiveness and secures a new job more quickly. The information components and elements described herein can be interchanged, reconfigured reset and otherwise customized in different combinations to include as described herein. In this manner, a job seeker, coach or reviewing peer uses embodiment(s) of the present invention to receive personalized feedback on a job search and specific, targeted advice for improving that search in a highly efficient manner.

What is claimed is:

1. A method of assessing the effectiveness of a job search comprising:
(a) generating a first set of information comprising employment search attributes and job seeker qualifications, wherein said first set of information is relevant to seeking at least one employment position;
(b) obtaining a second set of information comprising job market and hiring environment realities relevant to said at least one employment position;
(c) inputting the first and second sets of information into at least one computing device, whereby the computing device processes said first and second sets of information to create a variably structured data overlay;
(d) scoring the variably structured data overlay with the at least one computing device to derive at least one job search effectiveness rating and a detailed data package including strengths and weaknesses on the effectiveness of the job search; and
(e) outputting the at least one job search effectiveness rating and the detailed data package including strengths and weaknesses on the effectiveness of the job search as a multidimensional report that displays a comprehensive overview on the effectiveness of said job search.

2. The method of claim 1, wherein the first and second sets of information further comprise responses by said job seeker to a plurality of questions intended to elicit candid responses from said job seeker.

3. The method of claim 1, wherein the first and second sets of information further comprise input from a specialized web search engine operating on the at least one computing device, whereby the computing device processes said first and second sets of information to create said variably structured data overlay.

4. The method of claim 1, wherein the first and second sets of information comprise responses from a plurality of job seekers.

5. The method of claim 1, wherein the first and second sets of information comprise information extracted from a job seeker data source.

6. The method of claim 1, wherein a third set of information comprising mental and emotional characteristics of a job seeker relevant to said job search are input into the at least one computing device and scored along with said variably structured data overlay, and whereby a summary of said mental and emotional characteristics are included as part of said multidimensional report.

7. The method of claim 1, wherein said strengths and weakness are scored to arrive at a prioritized ranking of inhibitors to job search effectiveness, and whereby said prioritized ranking of inhibitors to job search effectiveness are included in the detailed data package.

8. The method of claim 1, wherein said strengths and weakness are scored to arrive at a prioritized list of action items for improving job search effectiveness, and whereby said prioritized list of action items for improving job search effectiveness are included in the detailed data package.

9. The method of claim 1, wherein the detailed data package including strengths and weaknesses on the effectiveness of the job search further comprises a plurality of incremental sub-rankings for said strengths and weakness.

10. The method of claim 1, wherein a later second multidimensional report is prepared in a manner consistent with said multidimensional report and said second multidimensional report is comparatively scored with said multidimensional report to provide a trending analysis.

11. An apparatus for assessing the effectiveness of a job search comprising:
(a) a first module for gathering a first set of employment search attributes and job seeker qualifications relevant to seeking at least one employment position;
(b) a second module for obtaining a second set of information comprising job market and hiring environment realities relevant to said at least one employment position;
(c) a processor for combining the first and second sets of information into a variably structured data overlay;
(d) a scorer for deriving at least one job search effectiveness rating and a detailed data package including strengths and weaknesses on the effectiveness of the job search; and
(e) a display for communicating the at least one job search effectiveness rating and the detailed data package including strengths and weaknesses as a multidimensional report.

12. The apparatus of claim 11, wherein the first and second sets of information further comprise responses by said job seeker to a plurality of questions intended to elicit candid responses from said job seeker.

13. The apparatus of claim 11, wherein the first and second sets of information further comprise input from a specialized web search engine operating on the at least one computing device, whereby the computing device processes said first and second sets of information to create said variably structured data overlay.

14. The apparatus of claim 11, wherein the first and second sets of information comprise responses from a plurality of job seekers.

15. The apparatus of claim 11, wherein the first and second sets of information comprise information extracted from a job seeker data source.

16. The apparatus of claim 11, wherein a third module collects a set of information comprising mental and emotional characteristics of a job seeker, whereby said third set of information is combined by the processor into the variably structured data overlay, wherein the scorer derives a mental and emotional characteristics rating for the job seeker, and wherein said emotional and psychological characteristics rating is communicated on the display.

17. The apparatus of claim 11, wherein said strengths and weakness are scored to arrive at a prioritized ranking of inhibitors to job search effectiveness, and whereby said prioritized ranking of inhibitors to job search effectiveness are communicated on the display.

18. The apparatus of claim 11, wherein said strengths and weakness further comprise a prioritized list of action items for improving job search effectiveness, and whereby said prioritized list of action items for improving job search effectiveness is communicated on the display.

19. The apparatus of claim 11, wherein the detailed data package including strengths and weaknesses on the effectiveness of the job search further comprises a plurality of incremental sub-rankings for said strengths and weakness.

20. The apparatus of claim 11, wherein a later second multidimensional report is prepared in a manner consistent with said multidimensional report and said second multidimensional report is comparatively scored with said multidimensional report to provide a trending analysis.
